(19) United States
(12) Patent Application Publication
(10) Pub. No.: US 2024/0369825 A1
(43) Pub. Date: Nov. 7, 2024

(54) MEMS Based Beam Steering with DC and Side Lobe Suppression

(71) Applicant: ARIZONA BOARD OF REGENTS ON BEHALF OF THE UNIVERSITY OF ARIZONA, Tucson, AZ (US)

(72) Inventor: Yuzuru Takashima, Tucson, AZ (US)

(73) Assignee: ARIZONA BOARD OF REGENTS ON BEHALF OF THE UNIVERSITY OF ARIZONA, Tucson, AZ (US)

(21) Appl. No.: 18/686,653

(22) PCT Filed: Aug. 25, 2022
(86) PCT No.: PCT/US22/41566

§ 371 Date: Feb. 26, 2024

Related U.S. Application Data
(60) Provisional application No. 63/236,776, filed on Aug. 25, 2021.

(51) Int. Cl. G02B 26/02; G01S 7/481; G02B 27/28

(52) U.S. Cl. CPC G02B 26/02; G02B 27/283; G02B 27/288; G01S 7/4817

(57) ABSTRACT

An optical system for modulating a light beam emitted by a laser light source. The system includes a phase light modulation device positioned to receive the laser light beam, a 4f relay optics positioned to receive light emitted from the phase light modulation device, and having a tilt mirror positioned in the light path, the tilt mirror having a center hole that permits light to pass therethrough and relay to a focusing lens, whereby a modulated and linearly polarized beam is transmitted; a quarter wave plate having a polarized beam splitter positioned to receive the modulated and linearly polarized beam; and a digital micromirror device that includes an array of micromirrors and that modulates amplitude of light in a pixelated manner by redirecting light into two directions, on- and off-directions, by electrically controlling the tilt angle of each micromirror.

### CROSS-REFERENCE TO RELATED APPLICATION

The present application relates and claims priority to U.S. Patent Application No. 63/236,776, filed Aug. 25, 2021, the entirety of which is hereby incorporated by reference.

### GOVERNMENT FUNDING

N/A

### FIELD OF THE INVENTION

The present disclosure is directed generally to spatial light modulator for beam steering as used in, for example, LIDAR applications.

### BACKGROUND

Laser beam steering is an essential function for lidar. Diffractive beam steering is inheritably low inertia steering mechanics and solid state that has higher reliability compared to purely mechanical beam steering modalities. In the diffractive beam steering, phase of laser is modulated in a pixelated manner. The phase tilt induced by the pixel tilts wavefront of the modulated laser that propagates along the direction perpendicular to the phase front. The drawback however is its small steering angle which is limited by wavelength/pixel period. For a laser beam steering with wide field of view, pixel pitch has to be smaller than half of the wavelength. Another critical factor in laser beam steering is suppression of side lobes. In general, laser beam steering by pixelated diffractive element suffers from side-lobes, diffraction of laser towards direction other than of interest, as well as 0th order DC diffraction, diffraction towards the direction along specular reflection.

Accordingly, there is a need in the art for laser beam steering that suppresses DC and side lobes

### SUMMARY

The present disclosure is directed to an optical architecture to reject side lobes while diffractively steer beam over several tens of degrees, which is not capable by only using conventional diffractive beam steering device such as LCoS whose pixel pitch is much larger than the wavelength.

According to an aspect is an optical system for modulating a light beam emitted by a laser light source, comprising a phase light modulation device positioned to receive the laser light beam; a 4f relay optics positioned to receive light emitted from the phase light modulation device, and having a tilt mirror and polarization selection device positioned in the light path, the tilt mirror having a center hole that permits light to pass therethrough and relay to a focusing lens, whereby a modulated and linearly polarized beam is transmitted; a quarter wave plate having a polarized beam splitter positioned to receive the modulated and linearly polarized beam; and a digital micromirror device comprising an array of micromirrors and that modulates amplitude of light in a pixelated manner by redirecting light into two directions, on- and off-direction, by electrically controlling the tilt angle of each micromirror.

Also, polarization selection device such as linear polarizer and wire grid polarizer is employed so that the side-lobes and diffracted beam of interest is separated in polarization domain.

According to an embodiment, the phase light modulation device is one of a liquid crystal on silicon and a MEMS phase light modulator.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1A-1D are schematic depictions of an optical architecture for a wide FOV and side-lobe and DC free laser beam steering, in accordance with an embodiment.

FIG. 2 shows beam patterns, in accordance with an embodiment.

FIG. 3 shows a demonstration of the concept by displaying pattern on DMD that rejects parasitic pattern while beam is collimated and steered to angular extent that exceed angular extent of PLM, in accordance with an embodiment.

FIG. 4A-4B are schematic representations of parasitic rejection and beam steering by PLM-DMD hybrid beam steering in first and second steps, respectively, in accordance with an embodiment.

FIG. 4C is a perspective view of an experimental set-up, in accordance with an embodiment.

### DETAILED DESCRIPTION OF EMBODIMENTS

The present disclosure describes a phase light modulator.

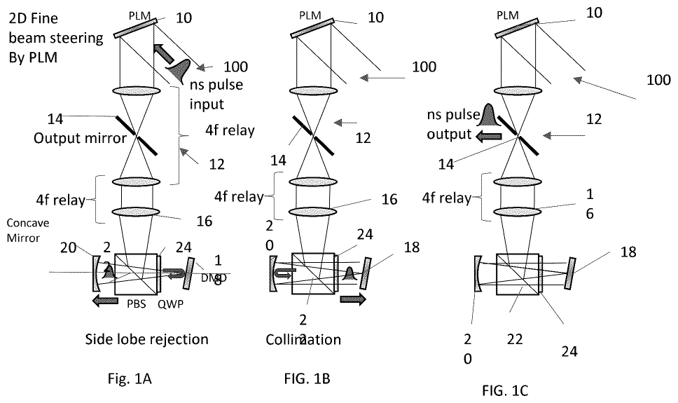

Referring to FIG. 1A-1D, in one embodiment, schematically depicted is an optical architecture for a wide FOV and side-lobe and DC free laser beam steering. The optical architecture is based on previously proposed Angular and Spatial Light Modulation technique as disclosed in U.S. patent application Ser. Nos. 16/955,285 and 16/955,359, both filed on Jun. 18, 2020, and incorporated herein by reference.

An incoming pulsed light 100 from laser is collimated and it illuminates phase light modulation (PLM) device 10, such as Liquid Crystal on Silicon (LCoS), MEMS Phase Light Modulator (PLM) and others. Phase of the PLM 10 is modulated in a way such that single or multiple beam are diffracted into the direction of interest. In some case, laser is modulated to form a holographic image, point clouds and such. The period of pixel of such PLM p is in general longer than the wavelength, therefore the beam diffraction angle is rather small, on the order of λ/p where λ is wavelength of the laser, and p is a pixel period of spatial light modulator. Also the phase modulation in general is discrete, for example 3˜8 bit due to the digital nature of signal that controls phase modulation depth.

A 4f-relay optics 12 with a tilt mirror 14 having a center hole relays light to a focusing lens 16. The 2^{nd} lens from the PLM of the f4-relay of 12 and the following the 3rd lens counted from the PLM is also an 4f-relay so that the tilted and 45 degree mirror and the digital micromirror device (DMD) are object and image. The discretely phase and space modulated beam is focused on a Digital Micromirror Device (DMD) 18 by a focusing lens 20. The DMD 18 is a spatial light modulator that consists of micromirror arrays.

DMD 18 modulates amplitude of light in a pixelated manner by redirecting light into two directions, on- and off-direction by electrically controlling the tilt angle of each micro mirrors. The DMD 18 is placed at the back focal plane of the focusing lens 20 which is knows as a Fourier transform plane of the PLM 10. Under ideal phase modulation to achieve a single point beam steering, the phase of the modulated laser is tilted but planer (plane wave). With a tilted plane wave, at the Fourier transform plane, only one diffraction spot that corresponds to beam steer angle of interest is observed. However in general 0th order diffraction (DC) term as well as other orders are observed due to the aforementioned discrete and pixelated phase modulation with PLMs. This is also the case for multiple point beam steering. For generation of holographic image, 0th order DC component appears too for phase only modulated holograms. Those undesirable diffraction orders other than Fourier components of interest are rejected by the DMD 18 while employing enhancement of diffraction angle as follows.

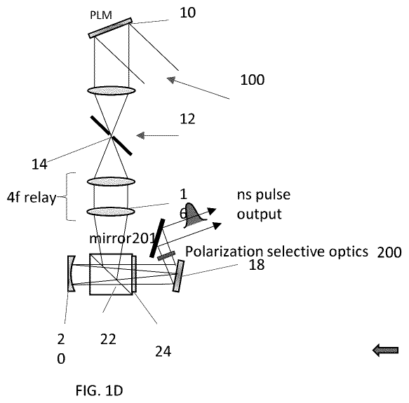

On DMD prior to beam steering, a pattern that rejects undesirable Fourier component is displayed (FIG. 2, DMD pattern 1) while micromirrors are in motion between the on and off states. Modulated and linearly polarized beam is reflected by Polarized Beam Splitter (PBS) 22 towards DMD 18 via Quarter Wave Plate (QWP) 24. The linearly polarized light for example vertically polarized, is converted to circular polarized light. Upon reflection of the circular polarized light, undesired components are redirected by off-pixels and reflected to a beam absorber by the pattern as depicted in FIG. 2. The beam of interest is reflected back to QWP 24 and converted to linearly polarized light but the direction of polarization is perpendicular to that of the incident light. Therefore the reflected beam this time is not reflected by PBS 22 and collimated by the mirror placed next to the PBS 22. The collimated beam illuminates DMD 2^{nd} time and steered. In this manner, PLM 10 takes care of fine steering while the fine steering pattern is sequentially duplicated by DMD-based diffractive beam steering as follows.

During the double reflection process, DMD mirror is actuated to display a 2^{nd} pattern as depicted. While transitioning from the initial pattern to the following pattern, the micromirrors of DMD corresponding to the undesirable pattern is not actuated while rest of the micromirrors are actuated. The transition of micromirror is synchronized to the pulse so that the tilt angle of the actuated micromirror satisfies Blaze condition. The diffracted beam is redirected towards the field angle outside of the PBS. The process is repeated for next beam steering sequence while updating the initial pattern to reject undesirable Fourier components.

FIG. 1D depicts another embodiment to use polarization selective device, such as polarizer, and wire grid reflective polarizer 200 to separate the rejected beam by 1st interaction with DMD 18 from the beam of interest by 2^{nd} interaction with DMD 18, by using the first and 2^{nd} interaction has orthogonal polarization. This embodiment enables rejection of side lobes even the side-lobes and beam of interest shares angular extent upon rejection of side-lobes and diffraction by DMD 18 for side-lobe rejected beam steering. The diffracted beam of interest is further deflected by mirror 201 to direct the beam off from the rest of the optics.

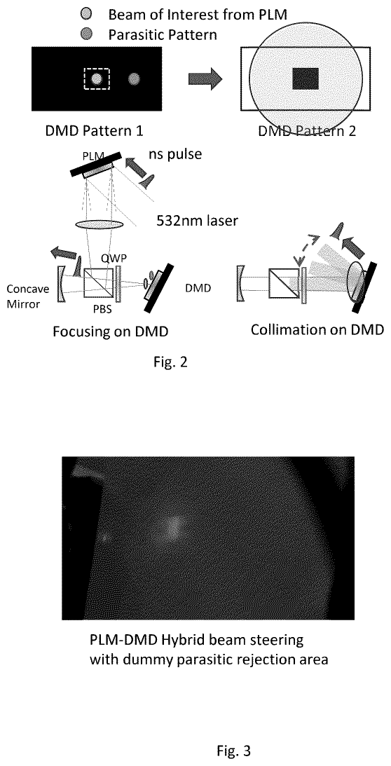

FIG. 3 shows demonstration of the concept by displaying pattern on DMD that rejects parasitic pattern while beam is collimated and steered to angular extent that exceed angular extent of PLM.

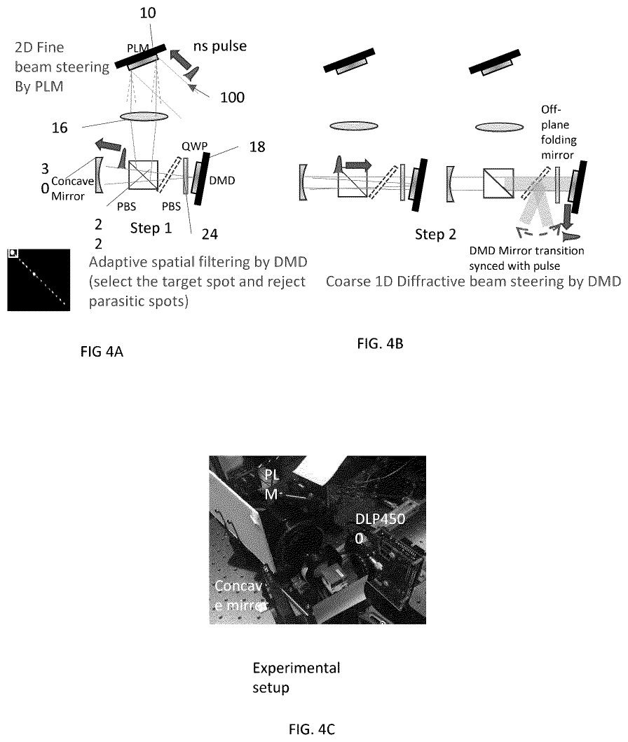

FIGS. 4A and 4B depicts the parasitic rejection and beam steering by PLM-DMD hybrid beam steering in two steps (step 1 FIG. 4A and step 2 FIG. 4B) via the time decomposition of the interaction with short pulse once with PLM 10 and twice with DMD 18. Step 1 shows that short incoming pulse is modulated by PLM 10. Since the incoming pulse is linearly polarized, via PBS 22, the modulated pattern is focused at DMD 18 at first time. For example, the modulated pattern is laser beam steering patter, side-lobes and un-necessary diffractions are filtered out by DMD 18 but beam of interest (BOM), shown in step 1 as a tightly focused spot on DMD 18 is redirected to PBS 22. With a QWP 24 between the PBS 22 and DMD 18, the reflected short pulse of BOM has a linear polarization which is perpendicular to the incoming short pulse, therefor, the reflected BOM transmits through the PBS 22, and is reflectively collimated by the concave mirror, as depicted in step 2. After the BOM is collimated by the concave mirror 30, the DMD 18 is still in motion but the tiel angle of micromirror in motion seldom changes due to the short round trip traveling length (i.e., 100 mm) and corresponding traveling time (ns) as compared to the mirror's transitional time (us). In this manner, the light interacts with DMD 18 twice while still satisfying the Blazed condition to steerer the only BOM in diffractive manner.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. An optical system for modulating a light beam emitted by a laser light source, comprising:
a. a phase light modulation device positioned to receive the laser light beam;
b. a 4f relay optics positioned to receive light emitted from the phase light modulation device, and having a tilt mirror positioned in the light path, the tilt mirror having a center hole that permits light to pass therethrough and relay to a focusing lens, whereby a modulated and linearly polarized beam is transmitted;
c. a quarter wave plate having a polarized beam splitter positioned to receive the modulated and linearly polarized beam; and
d. a digital micromirror device comprising an array of micromirrors and that modulates amplitude of light in a pixelated manner by redirecting light into two directions comprising an on direction and an off direction, by electrically controlling the tilt angle of each micromirror.

2. The optical system of claim 1, further comprising a polarizer that separates a rejected beam by a first interaction with the digital micromirror device from a diffracted beam by a second interaction of the beam with the digital micromirror device.

3. The system of claim 1, wherein the phase light modulation device is one of a liquid crystal on silicon and a MEMS phase light modulator.
